(19) United States
(12) Patent Application Publication
(10) Pub. No.: US 2018/0069660 A1
(43) Pub. Date: Mar. 8, 2018

(54) METHOD AND APPARATUS FOR PERFORMING DATA RATE MATCHING IN LICENSED ASSISTED ACCESS CARRIER IN WIRELESS COMMUNICATION SYSTEM

(71) Applicant: LG ELECTRONICS INC., Seoul (KR)

(72) Inventors: Yunjung YI, Seoul (KR); Joonkui AHN, Seoul (KR)

(21) Appl. No.: 15/556,965

(22) PCT Filed: Mar. 17, 2016
(86) PCT No.: PCT/KR2016/002731

§ 371 Date: Sep. 8, 2017

Related U.S. Application Data
(60) Provisional application No. 62/134,532, filed on Mar. 17, 2015.

(51) Int. Cl. H04L 1/00; H04B 7/26; H04L 27/26; H04L 1/08

(52) U.S. Cl. CPC H04L 1/0067; H04B 7/26; H04J 2011/0003; H04L 27/261; H04L 1/08; H04L 1/0013

(57) ABSTRACT

A method and apparatus for performing measurement in a wireless communication system is provided. A user equipment (UE) receives both an unlicensed discovery reference signal (U-DRS) and data burst simultaneously in subframes in which the UE is expected to receive a synchronization signal in an unlicensed carrier, and performs measurement by using the U-DRS. The subframes in which the UE is expected to receive the synchronization signal may be subframes having an index of 0 and 5.

### CROSS-REFERENCE TO RELATED APPLICATIONS

This application is the National Stage filing under 35 U.S.C. 371 of International Application No. PCT/KR2016/002731, filed on Mar. 17, 2016, which claims the benefit of U.S. Provisional Application No. 62/134,532 filed on Mar. 17, 2015, the contents of which are all hereby incorporated by reference herein in their entirety.

### BACKGROUND OF THE INVENTION

### Field of the Invention

The present invention relates to wireless communications, and more particularly, to a method and apparatus for performing data rate matching in a licensed-assisted access (LAA) carrier in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

LTE Advanced (LTE-A) offers considerably higher data rates than even the initial releases of LTE. While the spectrum usage efficiency has been improved, this alone cannot provide the required data rates that are being headlined for LTE-A. To achieve these very high data rates, it is necessary to increase the transmission bandwidths over those that can be supported by a single carrier or channel. The method being proposed is termed carrier aggregation (CA), or sometimes channel aggregation. Using LTE-A CA, it is possible to utilize more than one carrier and in this way increase the overall transmission bandwidth.

Further, as the demands on data rate keeps increasing, the utilization/exploration on new spectrum and/or higher data rate is essential. As one of a promising candidate, utilizing unlicensed spectrum, such as 5 GHz unlicensed national information infrastructure (U-NII) radio band, is being considered. As it is unlicensed, to be successful, necessary channel acquisition and completion/collision handling and avoidance are expected. This technology may be referred to as licensed-assisted access (LAA) or LTE in unlicensed spectrum (LTE-U).

To be able to efficient support UE cell association and inter-cell interference, etc., it is expected that a UE needs to perform measurements on both serving cells and neighbor cells in both intra and inter-frequency. Typically, measurement in LTE is based on periodic transmission of measurement/synchronization signals such as primary synchronization signal (PSS)/secondary synchronization signal (SSS) and cell-specific reference signal (CRS). However, due to nature of unlicensed spectrum, some enhancements may be required for LAA.

### SUMMARY OF THE INVENTION

The present invention provides a method and apparatus for performing data rate matching in a licensed-assisted access (LAA) carrier (or, long-term evolution in unlicensed spectrum (LTE-U) carrier) in a wireless communication system. The present invention provides a method and apparatus for performing data rate matching in a LAA carrier with a discovery reference signal (DRS) transmission. The present invention discusses data rate matching in a LAA carrier in case of periodic/aperiodic DRS transmission as well as periodic/aperiodic channel state information reference signal (CSI-RS) transmission.

In an aspect, a method for performing, by a user equipment (UE), measurement in a wireless communication system is provided. The method includes receiving both an unlicensed discovery reference signal (U-DRS) and data burst simultaneously in subframes in which the UE is expected to receive a synchronization signal in an unlicensed carrier, and performing measurement by using the U-DRS.

The subframes in which the UE is expected to receive the synchronization signal may be subframes having an index of 0 and 5.

In another aspect, a user equipment (UE) in a wireless communication system is provided. The UE includes a memory, a transceiver, and a processor coupled to the memory and the transceiver. The processor is configured to control the transceiver to receive both an unlicensed discovery reference signal (U-DRS) and data burst simultaneously in subframes in which the UE is expected to receive a synchronization signal in an unlicensed carrier, and perform measurement by using the U-DRS.

Data rate matching can be performed efficiently in a LAA carrier.

### BRIEF DESCRIPTION OF THE DRAWINGS

FIG. 1 shows a wireless communication system.

FIG. 2 shows structure of a radio frame of 3GPP LTE.

FIG. 3 shows a resource grid for one downlink slot.

FIG. 4 shows structure of a downlink subframe.

FIG. 5 shows structure of an uplink subframe.

FIG. 6 shows an example of U-DRS transmission according to an embodiment of the present invention.

FIG. 7 shows another example of U-DRS transmission according to an embodiment of the present invention.

FIG. 8 shows another example of U-DRS transmission according to an embodiment of the present invention.

FIG. 9 shows another example of U-DRS transmission according to an embodiment of the present invention.

FIG. 10 shows another example of U-DRS transmission according to an embodiment of the present invention.

FIG. 11 shows an example of data rate matching for U-DRS according to an embodiment of the present invention.

FIG. 12 shows another example of data rate matching for U-DRS according to an embodiment of the present invention.

FIG. 13 shows another example of data rate matching for U-DRS according to an embodiment of the present invention.

FIG. 14 shows another example of data rate matching for U-DRS according to an embodiment of the present invention.

FIG. 15 shows another example of data rate matching for U-DRS according to an embodiment of the present invention.

FIG. 16 shows another example of data rate matching for U-DRS according to an embodiment of the present invention.

FIG. 17 shows a method for performing measurement according to an embodiment of the present invention.

FIG. 18 shows a wireless communication system to implement an embodiment of the present invention.

### DESCRIPTION OF EXEMPLARY EMBODIMENTS

Techniques, apparatus and systems described herein may be used in various wireless access technologies such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented with a radio technology such as universal terrestrial radio access (UTRA) or CDMA2000. The TDMA may be implemented with a radio technology such as global system for mobile communications (GSM)/general packet radio service (GPRS)/enhanced data rates for GSM evolution (EDGE). The OFDMA may be implemented with a radio technology such as institute of electrical and electronics engineers (IEEE) 802.11 (Wi-Fi), IEEE 802.16 (WiMAX), IEEE 802-20, evolved-UTRA (E-UTRA) etc. The UTRA is a part of a universal mobile telecommunication system (UMTS). 3rd generation partnership project (3GPP) long term evolution (LTE) is a part of an evolved-UMTS (E-UMTS) using the E-UTRA. The 3GPP LTE employs the OFDMA in downlink (DL) and employs the SC-FDMA in uplink (UL). LTE-advance (LTE-A) is an evolution of the 3GPP LTE. For clarity, this application focuses on the 3GPP LTE/LTE-A. However, technical features of the present invention are not limited thereto.

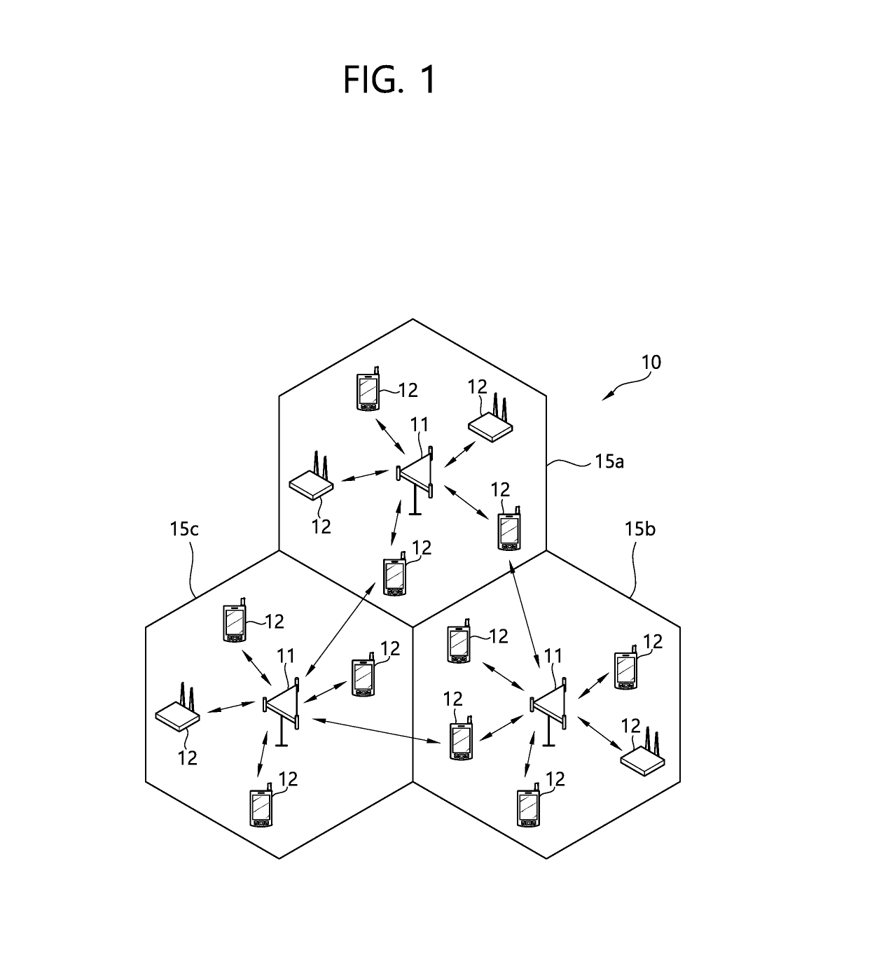

FIG. 1 shows a wireless communication system. The wireless communication system 10 includes at least one evolved NodeB (eNB) 11. Respective eNBs 11 provide a communication service to particular geographical areas 15a, 15b, and 15c (which are generally called cells). Each cell may be divided into a plurality of areas (which are called sectors). A user equipment (UE) 12 may be fixed or mobile and may be referred to by other names such as mobile station (MS), mobile terminal (MT), user terminal (UT), subscriber station (SS), wireless device, personal digital assistant (PDA), wireless modem, handheld device. The eNB 11 generally refers to a fixed station that communicates with the UE 12 and may be called by other names such as base station (BS), base transceiver system (BTS), access point (AP), etc.

In general, a UE belongs to one cell, and the cell to which a UE belongs is called a serving cell. An eNB providing a communication service to the serving cell is called a serving eNB. The wireless communication system is a cellular system, so a different cell adjacent to the serving cell exists. The different cell adjacent to the serving cell is called a neighbor cell. An eNB providing a communication service to the neighbor cell is called a neighbor eNB. The serving cell and the neighbor cell are relatively determined based on a UE.

This technique can be used for DL or UL. In general, DL refers to communication from the eNB 11 to the UE 12, and UL refers to communication from the UE 12 to the eNB 11. In DL, a transmitter may be part of the eNB 11 and a receiver may be part of the UE 12. In UL, a transmitter may be part of the UE 12 and a receiver may be part of the eNB 11.

The wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmission antennas and a plurality of reception antennas. The MISO system uses a plurality of transmission antennas and a single reception antenna. The SISO system uses a single transmission antenna and a single reception antenna. The SIMO system uses a single transmission antenna and a plurality of reception antennas. Hereinafter, a transmission antenna refers to a physical or logical antenna used for transmitting a signal or a stream, and a reception antenna refers to a physical or logical antenna used for receiving a signal or a stream.

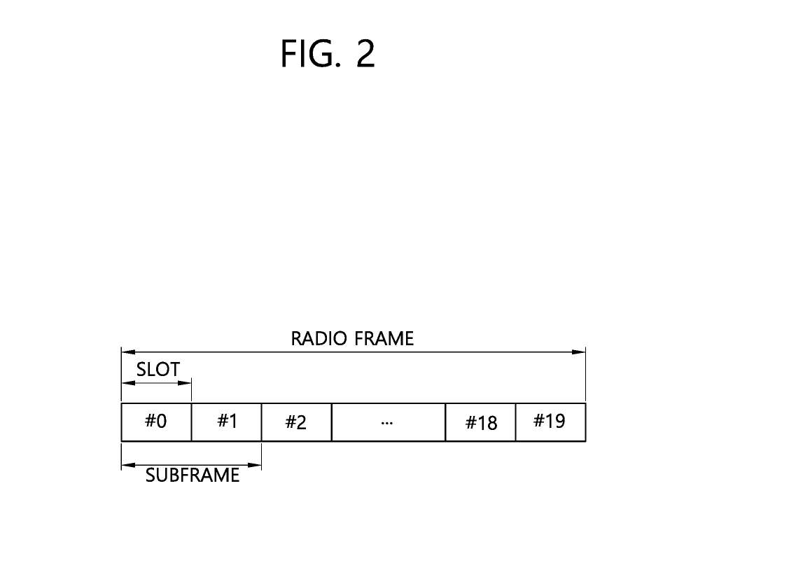

FIG. 2 shows structure of a radio frame of 3GPP LTE. Referring to FIG. 2, a radio frame includes 10 subframes. A subframe includes two slots in time domain. A time for transmitting one subframe is defined as a transmission time interval (TTI). For example, one subframe may have a length of 1 ms, and one slot may have a length of 0.5 ms. One slot includes a plurality of orthogonal frequency division multiplexing (01-DM) symbols in time domain. Since the 3GPP LTE uses the OFDMA in the DL, the OFDM symbol is for representing one symbol period. The OFDM symbols may be called by other names depending on a multiple-access scheme. For example, when SC-FDMA is in use as a UL multi-access scheme, the OFDM symbols may be called SC-FDMA symbols. A resource block (RB) is a resource allocation unit, and includes a plurality of contiguous subcarriers in one slot. The structure of the radio frame is shown for exemplary purposes only. Thus, the number of subframes included in the radio frame or the number of slots included in the subframe or the number of OFDM symbols included in the slot may be modified in various manners.

A frame structure type 1 is applicable to frequency division duplex (FDD) only. For FDD, 10 subframes are available for DL transmission and 10 subframes are available for UL transmissions in each 10 ms interval. UL and DL transmissions are separated in the frequency domain. In half-duplex FDD operation, the UE cannot transmit and receive at the same time while there are no such restrictions in full-duplex FDD.

A frame structure type 2 is applicable to time division duplex (TDD) only. The UL-DL configuration in a cell may vary between frames and controls in which subframes UL or DL transmissions may take place in the current frame. The supported UL-DL configurations are listed in Table 1.

TABLE 1

| UL-DL | DL-to-UL | | | | | | | | | | | |
|---|---|---|---|---|---|---|---|---|---|---|---|---|
| config- | Switch-point | | | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In Table 1, for each subframe in a radio frame, “D” denotes a DL subframe reserved for DL transmissions, “U” denotes an UL subframe reserved for UL transmissions and “S” denotes a special subframe with the three fields downlink pilot time slot (DwPTS), guard period (GP) and uplink pilot time slot (UpPTS).

UL-DL configurations with both 5 ms and 10 ms DL-to-UL switch-point periodicity are supported. In case of 5 ms DL-to-UL switch-point periodicity, the special subframe exists in both half-frames. In case of 10 ms DL-to-UL switch-point periodicity, the special subframe exists in the first half-frame only. Subframes 0 and 5 and DwPTS are always reserved for DL transmission. UpPTS and the subframe immediately following the special subframe are always reserved for UL transmission.

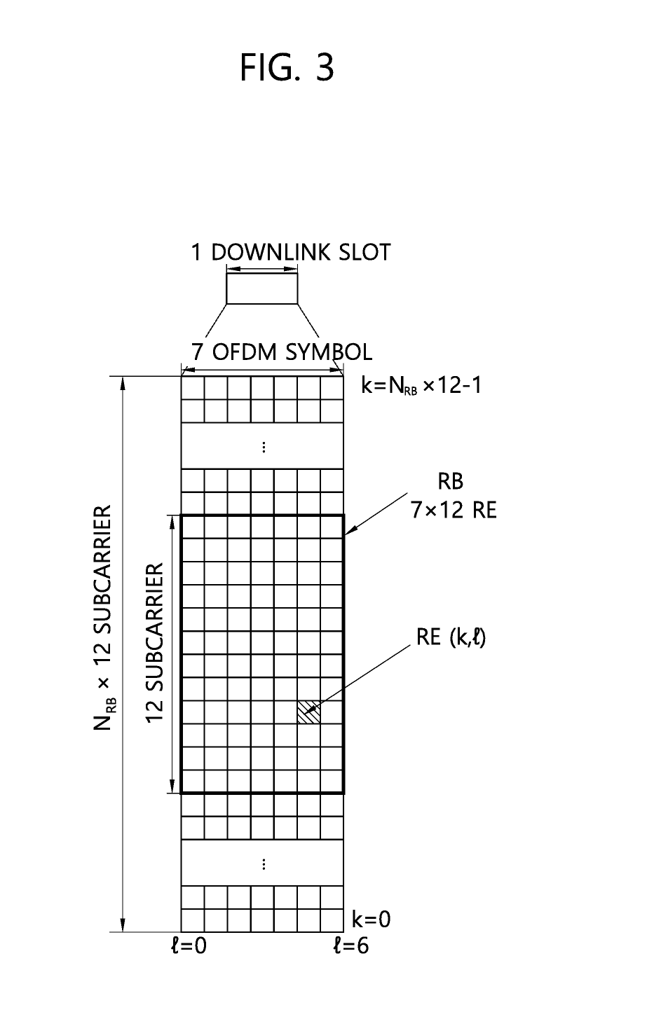

FIG. 3 shows a resource grid for one downlink slot. Referring to FIG. 3, a DL slot includes a plurality of OFDM symbols in time domain. It is described herein that one DL slot includes 7 OFDM symbols, and one RB includes 12 subcarriers in frequency domain as an example. However, the present invention is not limited thereto. Each element on the resource grid is referred to as a resource element (RE). One RB includes 12×7 resource elements. The number N^{DL} of RBs included in the DL slot depends on a DL transmit bandwidth. The structure of a UL slot may be same as that of the DL slot. The number of OFDM symbols and the number of subcarriers may vary depending on the length of a CP, frequency spacing, etc. For example, in case of a normal cyclic prefix (CP), the number of OFDM symbols is 7, and in case of an extended CP, the number of OFDM symbols is 6. One of 128, 256, 512, 1024, 1536, and 2048 may be selectively used as the number of subcarriers in one OFDM symbol.

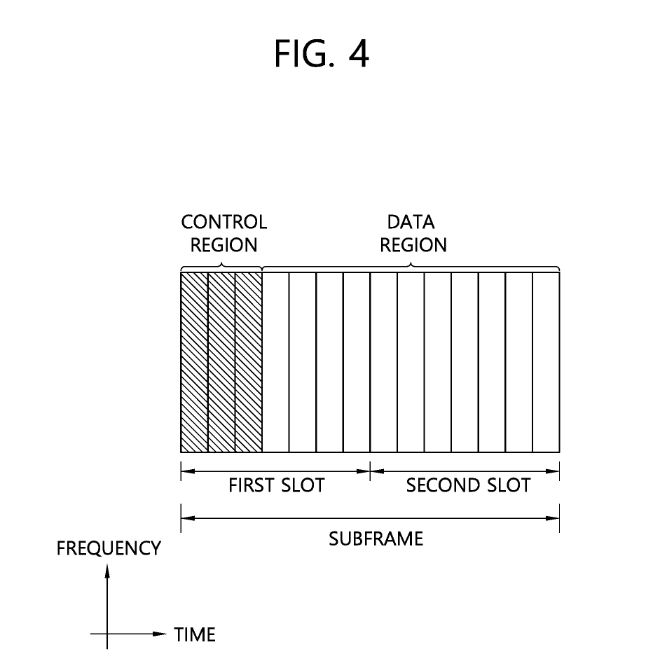

FIG. 4 shows structure of a downlink subframe. Referring to FIG. 4, a maximum of three OFDM symbols located in a front portion of a first slot within a subframe correspond to a control region to be assigned with a control channel The remaining OFDM symbols correspond to a data region to be assigned with a physical downlink shared chancel (PDSCH). Examples of DL control channels used in the 3GPP LTE includes a physical control format indicator channel (PCFICH), a physical downlink control channel (PDCCH), a physical hybrid automatic repeat request (HARQ) indicator channel (PHICH), etc. The PCFICH is transmitted at a first OFDM symbol of a subframe and carries information regarding the number of OFDM symbols used for transmission of control channels within the subframe. The PHICH is a response of UL transmission and carries a HARQ acknowledgment (ACK)/non-acknowledgment (NACK) signal. Control information transmitted through the PDCCH is referred to as downlink control information (DCI). The DCI includes UL or DL scheduling information or includes a UL transmit (Tx) power control command for arbitrary UE groups.

The PDCCH may carry a transport format and a resource allocation of a downlink shared channel (DL-SCH), resource allocation information of an uplink shared channel (UL-SCH), paging information on a paging channel (PCH), system information on the DL-SCH, a resource allocation of an upper-layer control message such as a random access response transmitted on the PDSCH, a set of Tx power control commands on individual UEs within an arbitrary UE group, a Tx power control command, activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups.

A format of the PDCCH and the number of bits of the available PDCCH are determined according to a correlation between the number of CCEs and the coding rate provided by the CCEs. The eNB determines a PDCCH format according to a DCI to be transmitted to the UE, and attaches a cyclic redundancy check (CRC) to control information. The CRC is scrambled with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be scrambled to the CRC. Alternatively, if the PDCCH is for a paging message, a paging indicator identifier (e.g., paging-RNTI (P-RNTI)) may be scrambled to the CRC. If the PDCCH is for system information (more specifically, a system information block (SIB) to be described below), a system information identifier and a system information RNTI (SI-RNTI) may be scrambled to the CRC. To indicate a random access response that is a response for transmission of a random access preamble of the UE, a random access-RNTI (RA-RNTI) may be scrambled to the CRC.

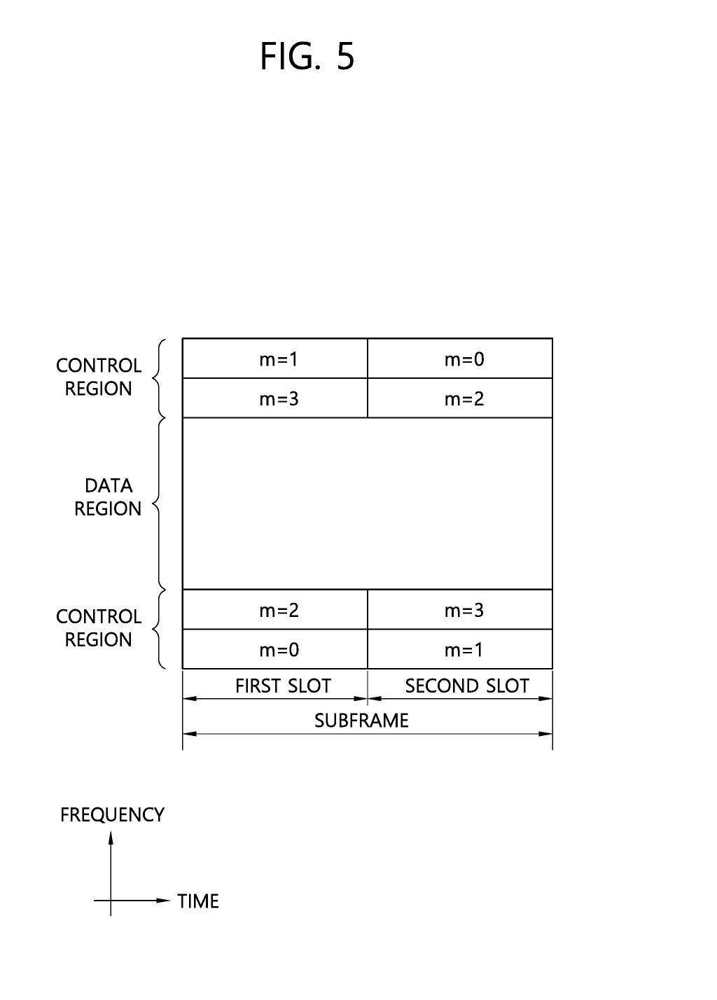

FIG. 5 shows structure of an uplink subframe. Referring to FIG. 5, a UL subframe can be divided in a frequency domain into a control region and a data region. The control region is allocated with a physical uplink control channel (PUCCH) for carrying UL control information. The data region is allocated with a physical uplink shared channel (PUSCH) for carrying user data. When indicated by a higher layer, the UE may support a simultaneous transmission of the PUSCH and the PUCCH. The PUCCH for one UE is allocated to an RB pair in a subframe. RBs belonging to the RB pair occupy different subcarriers in respective two slots. This is called that the RB pair allocated to the PUCCH is frequency-hopped in a slot boundary. This is said that the pair of RBs allocated to the PUCCH is frequency-hopped at the slot boundary. The UE can obtain a frequency diversity gain by transmitting UL control information through different subcarriers according to time.

UL control information transmitted on the PUCCH may include a HARQ ACK/NACK, a channel quality indicator (CQI) indicating the state of a DL channel, a scheduling request (SR), and the like. The PUSCH is mapped to a UL-SCH, a transport channel. UL data transmitted on the PUSCH may be a transport block, a data block for the UL-SCH transmitted during the TTI. The transport block may be user information. Or, the UL data may be multiplexed data. The multiplexed data may be data obtained by multiplexing the transport block for the UL-SCH and control information. For example, control information multiplexed to data may include a CQI, a precoding matrix indicator (PMI), an HARQ, a rank indicator (RI), or the like. Or the UL data may include only control information.

Carrier aggregation (CA) is described. In CA, two or more component carriers (CCs) are aggregated in order to support wider transmission bandwidths up to 100 MHz. A UE may simultaneously receive or transmit on one or multiple CCs depending on its capabilities. A UE with single timing advance (TA) capability for CA can simultaneously receive and/or transmit on multiple CCs corresponding to multiple serving cells sharing the same timing advance (multiple serving cells grouped in one timing advance group (TAG)). A UE with multiple TA capability for CA can simultaneously receive and/or transmit on multiple CCs corresponding to multiple serving cells with different TAs (multiple serving cells grouped in multiple TAGs). E-UTRAN ensures that each TAG contains at least one serving cell. A non-CA capable UE can receive on a single CC and transmit on a single CC corresponding to one serving cell only (one serving cell in one TAG). The CA is supported for both contiguous and non-contiguous CCs with each CC limited to a maximum of 110 resource blocks in the frequency domain.

It is possible to configure a UE to aggregate a different number of CCs originating from the same eNB and of possibly different bandwidths in the UL and the DL. The number of DL CCs that can be configured depends on the DL aggregation capability of the UE. The number of UL CCs that can be configured depends on the UL aggregation capability of the UE. It is not possible to configure a UE with more UL CCs than DL CCs. In TDD deployments, the number of CCs and the bandwidth of each CC in UL and DL is the same. The number of TAGs that can be configured depends on the TAG capability of the UE. CCs originating from the same eNB need not to provide the same coverage.

When CA is configured, the UE only has one RRC connection with the network. At RRC connection establishment/re-establishment/handover, one serving cell provides the non-access stratum (NAS) mobility information (e.g. tracking area identity (TAI)), and at RRC connection re-establishment/handover, one serving cell provides the security input. This cell is referred to as the primary cell (PCell). In the DL, the carrier corresponding to the PCell is the DL primary CC (DL PCC), while in the UL, it is the UL primary CC (UL PCC).

Depending on UE capabilities, secondary cells (SCells) can be configured to form, together with the PCell, a set of serving cells. In the DL, the carrier corresponding to a SCell is a DL secondary CC (DL SCC), while in the UL, it is an UL secondary CC (UL SCC).

Therefore, the configured set of serving cells for a UE always consists of one PCell and one or more SCells. For each SCell, the usage of UL resources by the UE in addition to the DL resources is configurable (the number of DL SCCs configured is therefore always larger than or equal to the number of UL SCCs and no SCell can be configured for usage of UL resources only). From a UE viewpoint, each UL resource only belongs to one serving cell. The number of serving cells that can be configured depends on the aggregation capability of the UE. PCell can only be changed with handover procedure (i.e. with security key change and random access channel (RACH) procedure). PCell is used for transmission of PUCCH. Unlike SCells, PCell cannot be de-activated. Re-establishment is triggered when PCell experiences radio link failure (RLF), not when SCells experience RLF. NAS information is taken from PCell.

Licensed-assisted access (LAA) (or, LTE in unlicensed spectrum (LTE-U)) is described. LAA refers to CA with at least one SCell operating in the unlicensed spectrum. In LAA, the configured set of serving cells for a UE therefore always includes at least one SCell operating in the unlicensed spectrum, also called LAA SCell. Unless otherwise specified, LAA SCells act as regular SCells and are limited to DL transmissions. By introduction of LAA, two or more CCs may be aggregated in order to support wider transmission bandwidths up to 640 MHz.

By the nature of unlicensed spectrum, it is expected that each device using the unlicensed spectrum should apply a type of polite access mechanism not to monopolize the medium and not to interfere on-going transmission. As a basic rule of coexistence between LAA devices and Wi-Fi devices, it may be assumed that on-going transmission should not be interrupted or should be protected by proper carrier sensing mechanism. In other words, if the medium is detected as busy, the potential transmitter should wait until the medium becomes idle. The definition of idle may depend on the threshold of carrier sensing range. As LTE is designed based on the assumption that a UE can expect DL signals from the network at any given moment (i.e., exclusive use), LTE protocol needs to be tailored to be used in non-exclusive manner In terms of non-exclusive manner, overall two approaches may be considered. One is to allocate time in a semi-static or static manner (for example, during day time, exclusive use, and during night time, not used by LTE), and the other is to compete dynamically for acquiring the channel. The reason for the completion is to handle other radio access technology (RAT) devices/networks and also other operator's LTE devices/networks.

Accordingly, LAA eNB applies listen-before-talk (LBT) before performing a transmission on LAA SCell. When LBT is applied, the transmitter listens to/senses the channel to determine whether the channel is free or busy. If the channel is determined to be free, the transmitter may perform the transmission. Otherwise, it does not perform the transmission. If an LAA eNB uses channel access signals of other technologies for the purpose of LAA channel access, it shall continue to meet the LAA maximum energy detection threshold requirement.

In unlicensed spectrum where LTE devices may coexist with other radio access technology (RAT) devices such as Wi-Fi, Bluetooth, etc., it is necessary to allow a UE behavior adapting various scenarios. In LAA, various aspects for 3GPP LTE described above may not be applied for LAA. For example, a frame structure 3 may be applicable for LAA SCell operation only. The 10 subframes within a radio frame may be available for DL transmissions. DL transmissions occupy one or more consecutive subframes, starting anywhere within a subframe and ending with the last subframe either fully occupied or following one of the DwPTS durations. For another example, the TTI described above may not be used for LAA carrier where variable or floating TTI may be used depending on the schedule and/or carrier sensing results. For another example, in LAA carrier, rather than utilizing a fixed DL/UL configuration, dynamic DL/UL configuration based on scheduling may be used. However, due to UE characteristics, either DL or UL transmission may occur at time. For another example, different number of subcarriers may also be utilized for LAA carrier.

Due to its nature of unlicensed spectrum which should be shared by multiple users, it becomes a bit challenging to assume consistently periodic transmission of any type of signals. Furthermore, it is also hard to assume that signals will be transmitted with certain probability or the frequency of signal transmission is maintained as a certain value. Given the challenges of unlicensed spectrum to transmit periodic signals, some tailorization/modification of UE measurement in unlicensed spectrum may be necessary.

A discovery signal occasion for a cell consists of a period with a duration of one to five consecutive subframes for frame structure type 1, two to five consecutive subframes for frame structure type 2, 12 OFDM symbols within one non-empty subframe for frame structure type 3. The UE in the DL subframes may assume presence of a discovery signal consisting of cell-specific reference signals (CRSs) on antenna port 0 in all DL subframes and in DwPTS of all special subframes in the period, primary synchronization signal (PSS) in the first subframe of the period for frame structure types 1 and 3 or the second subframe of the period for frame structure type 2, secondary synchronization signal (SSS) in the first subframe of the period, and non-zero-power channel state information reference signals (CSI RSs) in zero or more subframes in the period. For frame structures 1 and 2, the UE may assume a discovery signal occasion once every dmtc-Periodicity. For frame structure type 3, the UE may assume a discovery signal occasion may occur in any subframe within the discovery signals measurement timing configuration (DMTC).

To support various types of measurements, a type of discovery signal may be transmitted in unlicensed spectrum. For the convenience, this discovery signal may be referred to as unlicensed discovery reference signal (U-DRS). Due to regulatory constraints, transmission of U-DRS may not occur periodically as assumed in DRS transmission in small cell scenarios. In some cases, U-DRS transmission may be allowed without carrier sensing and/or LBT, yet, in some cases, even U-DRS may also apply carrier sensing and/or LBT.

Hereinafter, the present invention discusses detailed options related to U-DRS transmission assuming carrier sensing and/or LBT operation before transmission, and further discusses data rate matching when data transmission (hereinafter, D-Burst) and U-DRS transmission overlap with each other partially or fully in time.

First, detailed options related to U-DRS transmission assuming carrier sensing and/or LBT operation before transmission are described according to embodiments of the present invention. When LBT is performed, at least one of the following options may be considered for U-DRS transmission.

(1) U-DRS may be transmitted periodically. At the beginning of U-DRS transmission, LBT may be performed. LBT may be performed at every DRS occasion. If the channel is busy at the point, U-DRS may be dropped (i.e. not transmitted).

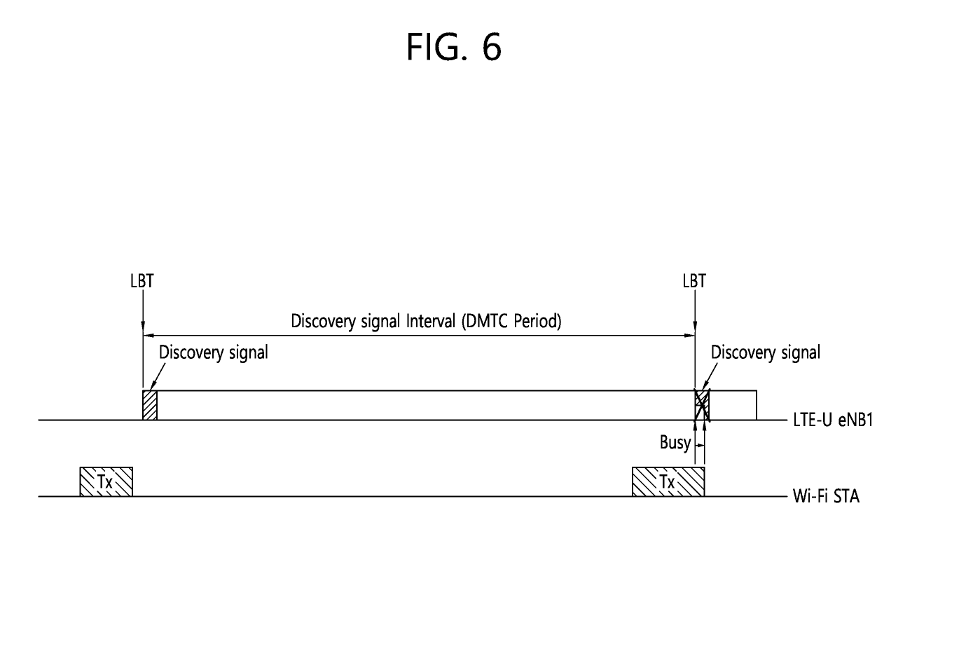

FIG. 6 shows an example of U-DRS transmission according to an embodiment of the present invention. Referring to FIG. 6, at the beginning of first U-DRS transmission, it is detected that Wi-Fi station (STA) does not transmit a signal via LBT. Therefore, LTE-U eNB1 transmits U-DRS. At the beginning of second U-DRS transmission, it is detected that Wi-Fi STA transmits a signal via LBT. Since the channel is busy, the LTE-U eNB1 does not transmit U-DRS, and U-DRS is dropped.

(2) DRS may be transmitted periodically. A UE may be configured with a DMTC window. The duration of DMTC window may be fixed as 6 ms or may be higher-layer configured. U-DRS may be transmitted in a DMTC window. The gap between the starting of a DMTC window and U-DRS may be fixed for a given cell. At the beginning of DMTC window, LBT may be performed. That is, LBT may be performed at every DMTC window. If the channel is busy at that point, U-DRS may not be transmitted in the DMTC window. If the channel is idle at that point, reservation signals may be transmitted until the starting of transmission of U-DRS. This reservation signal may be different from reservation signals used for occupying the channels for data transmission. This reservation signal may be read by other cells as well which may also transmit U-DRS. In other words, this reservation signal may be excluded from the carrier sensing threshold or detection of signals. In fact, this reservation signal may be considered as guarantee the medium for U-DRS transmission for other cells as well. This may be applied to cells belonging to the same operator.

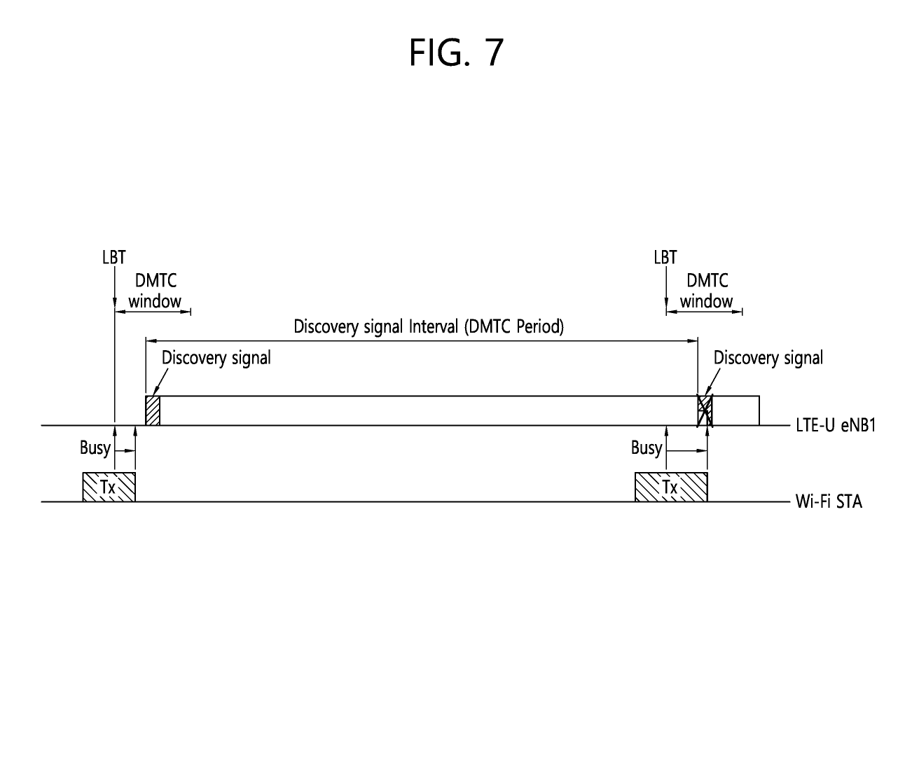

FIG. 7 shows another example of U-DRS transmission according to an embodiment of the present invention. Referring to FIG. 7, at the beginning of first DMTC window, it is detected that Wi-Fi STA transmits a signal via LBT. Since the channel is busy, the LTE-U eNB1 does not transmit U-DRS, and U-DRS is dropped. At the beginning of second DMTC window, it is detected that Wi-Fi STA transmits a signal via LBT. Since the channel is busy, the LTE-U eNB1 does not transmit U-DRS, and U-DRS is dropped.

(2-1) For one variation of option (2) described above, U-DRS transmission may be allowed within a DMTC window. For example, DMTC window may be configured as 6 ms, and U-DRS occasion duration may be configured as 1 ms. U-DRS occasion may occur any time within DMTC window based on LBT. As long as at least one full subframe (or a configured duration for the minimum DRS occasion) of U-DRS is transmitted within a DMTC window, it may be considered as a valid U-DRS transmission. That is, LBT may be performed at every DMTC window, and flexible U-DRS transmission may be performed within DMTC window.

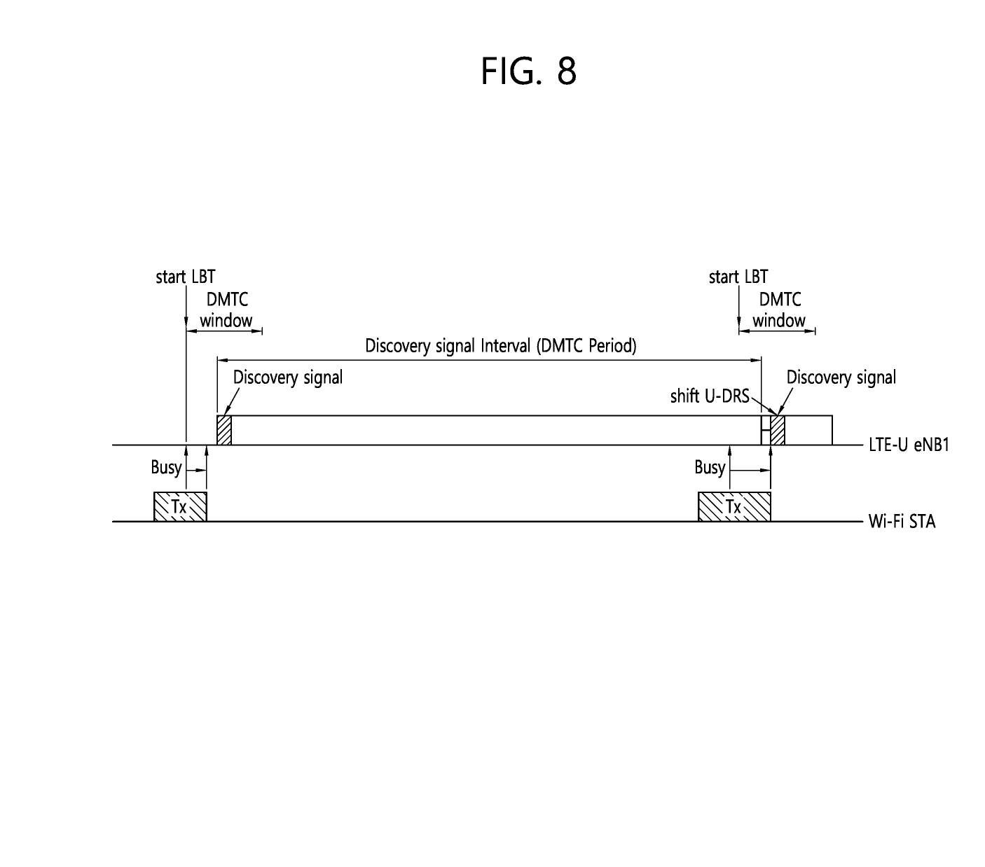

FIG. 8 shows another example of U-DRS transmission according to an embodiment of the present invention. Referring to FIG. 8, at the beginning of first DMTC window, it is detected that Wi-Fi STA transmits a signal via LBT. Even though the channel is busy at that point, since U-DRS can be transmitted within the first DMTC window, the LTE-U eNB1 transmits U-DRS at the first DRS occasion after the channel becomes idle. At the beginning of second DMTC window, it is detected that Wi-Fi STA transmits a signal via LBT. Even though the channel is busy at that point, since U-DRS can be transmitted within the second DMTC window, the LTE-U eNB1 transmits U-DRS after the channel becomes idle. Since the channel is busy at the second DRS occasion, transmission of U-DRS in the second DMTC windows is shifted after the channel becomes idle.

(2-2) For another variation of option (2) described above, LBT may be performed at starting of a DMTC window. If the channel is busy, LBT may be performed continuously until the starting of transmission of U-DRS. If the channel is idle at that point, U-DRS may be transmitted. Otherwise, U-DRS may be dropped. That is, LBT may be performed at every DMTC window, and fixed U-DRS transmission may be performed within DMTC window.

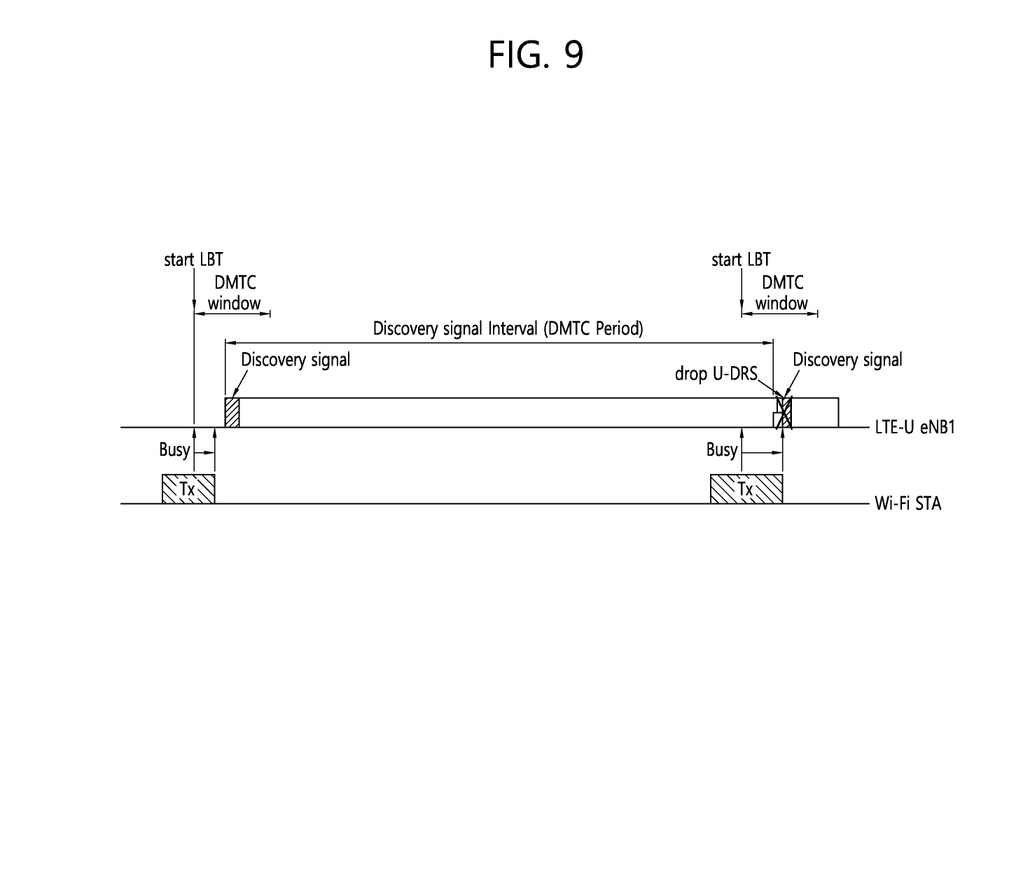

FIG. 9 shows another example of U-DRS transmission according to an embodiment of the present invention. Referring to FIG. 9, at the beginning of first DMTC window, it is detected that Wi-Fi STA transmits a signal via LBT. The LTE-U eNB1 continuously performs LBT until starting of transmission of U-DRS. Since the channel is idle at the starting of transmission of U-DRS, the LTE-U eNB1 transmits U-DRS. At the beginning of second DMTC window, it is detected that Wi-Fi STA transmits a signal via LBT. The LTE-U eNB1 continuously performs LBT until starting of transmission of U-DRS. Since the channel is still busy at the starting of transmission of U-DRS, the LTE-U eNB1 does not transmit U-DRS.

(2-3) For another variation of option (2) described above, LBT may be performed during a DMTC window. If the channel becomes idle, and at least one full subframe (or a configured duration for the minimum DRS occasion) is secured, U-DRS may be transmitted. Otherwise, U-DRS may be dropped. That is, LBT may be performed at every DMTC window, and fixed U-DRS transmission may be performed within DMTC window with partial transmission of U-DRS.

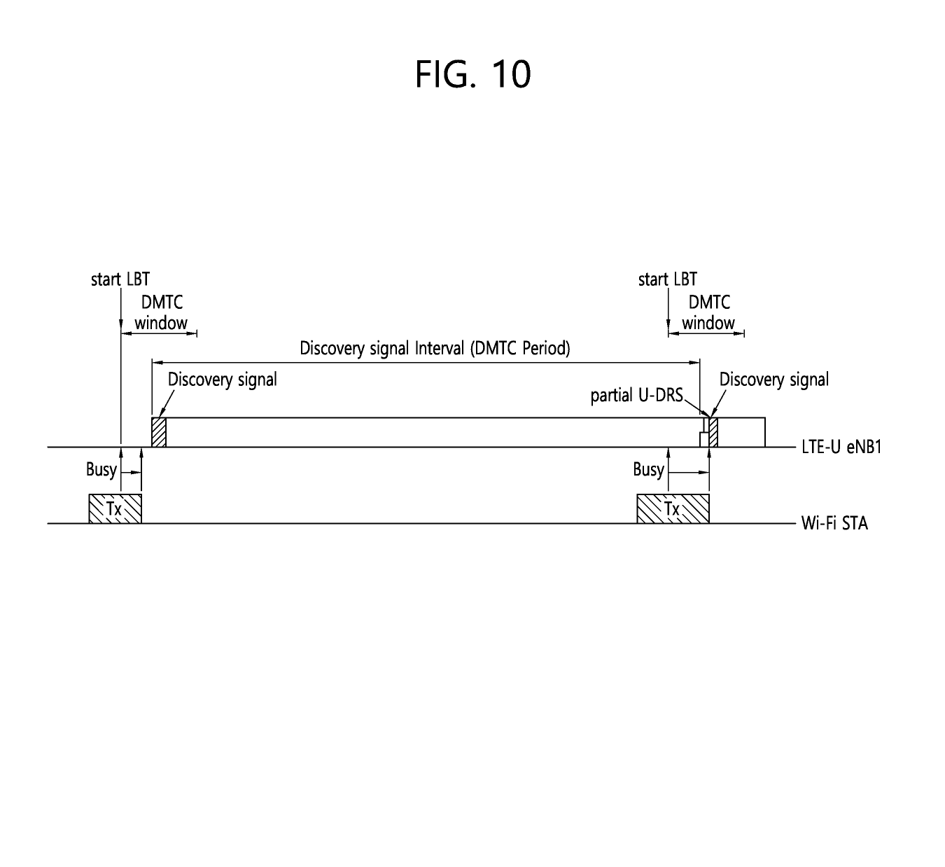

FIG. 10 shows another example of U-DRS transmission according to an embodiment of the present invention. Referring to FIG. 10, during first DMTC window, it is detected that Wi-Fi STA transmits a signal via LBT. After the channel becomes idle, the LTE-U eNB1 transmits U-DRS. During second DMTC window, it is detected that Wi-Fi STA transmits a signal via LBT. After the channel becomes idle, the LTE-U eNB1 transmits partial U-DRS.

Each option described above has pros and cons from the measurement perspective and transmission perspective. More specifically, when option (2-1) or option (2-3) is adopted, it is possible that the whole duration of U-DRS may not be transmitted within one DMTC window. For example, if U-DRS occasion duration is configured as 5 ms and DMTC window is configured as 6 ms, and if channel becomes idle after 2 ms since the starting of DMTC window, only 4 ms of U-DRS can be transmitted at best. In either option, minimum DRS duration may be additionally defined. The minimum DRS occasion is a threshold value that a UE considers the transmitted U-DRS as a valid U-DRS occasion if U-DRS has been transmitted more than minimum DRS duration within a DMTC window. For a UE not requiring a measurement gap, DMTC window may be configured or assumed as the same as DMTC interval/periodicity. This may be applied only for option (2-1). In general, a UE may expect U-DRS transmission from a cell where the duration is in between minimum DRS duration and maximum DRS duration. If only one configuration is given, a UE may assume that configuration as a minimum DRS occasion duration rather than the maximum or fixed DRS occasion duration if option (2-1) or option (2-3) used. In that case, maximum DRS occasion may be the duration of DMTC windows. For this, the performance of measurement is based on the minimum DRS duration rather than a fixed or maximum DRS duration.

The present invention mainly focuses on option (2-1) and/or option (2-3), and mainly discusses the relationship between U-DRS transmission and D-Burst transmission from the rate matching perspective.

In small cell DRS transmission, DRS may be transmitted within DMTC windows periodically. In other words, from a cell perspective, the offset or the gap between the starting of a DMTC window and DRS transmission is fixed, and a UE may expect periodic DRS transmission. Also, in small cell DRS transmission, SSS may be transmitted at either subframe #0 or #5. In other words, SSS may be transmitted only either subframe #0 or #5 regardless of DMTC/DRS configuration from a serving cell. Thus, generally in small cell DRS transmission, data rate matching at each subframe may be somewhat deterministic. For example, SSS may be rate matched in subframe #0 or #5, and PBCH may be rate matched in subframe #0 and so on. In LAA, depending on D-Burst transmission (i.e. what signals are transmitted and where signals are transmitted), depending on CSI-RS transmission, and also depending on U-DRS transmission mechanism, rate-matching per each subframe may be affected.

In terms of subframe index, subframe index of LAA cell may be aligned with PCell or primary SCell (pSCell). In case LAA is used as pSCell, subframe index may be determined as #0 in which PBCH-like master information block (MIB) is transmitted. Or, subframe index may be determined by PBCH-like MIB transmission. System frame number (SFN) may also be aligned with PCell or pSCell. Alternatively, subframe index #0 may be used for each D-Burst. If D-burst is greater than 10 subframes, subframe index may be repeated. In other words, only subframe index #0-#9 may be used. However, larger number of subframe indices may also be used. For example subframe index #0-#39 may be used to accommodate 40 subframes/mini-subframes within a radio frame.

Regardless of subframe index/SFN, which signals are transmitted per each subframe may follow one of options described below.

(1) Option 1: Synchronization signal(s) may be transmitted in the first subframe or the first mini-subframe of D-Burst. Reference signals may be transmitted at least in the first subframe or the first mini-subframe of D-Burst. In this case, a UE has to detect the first subframe/mini-subframe of D-Burst. To detect the first subframe/mini-subframe of D-Burst, the UE may detect preamble which is supposed to be always transmitted before D-Burst. Or, the UE may detect synchronization signal(s) which is supported to be transmitted in the first subframe/mini-subframe of D-Burst.

(2) Option 2: Synchronization signal(s) may be transmitted either in subframe #0 or #5 or subframes where legacy synchronization signals are transmitted in the associated L-Cell. In other words, synchronization signals may be transmitted with aligned with the associated licensed carrier.

(3) Option 3: Synchronization signal(s) may be transmitted only in U-DRS occasion. In D-Burst, unless it is overlapped with U-DRS occasion, synchronization signal(s) may not be expected.

Similar to small cell DRS transmission, U-DRS may also consist of multiple signals, i.e. synchronization signal(s) and reference signals. Thus, when U-DRS occasion and D-Burst overlap with each other, UE data rate matching may be ambiguous. For example, since rate matching is for a serving cell, there may be three cases of overlapping between U-DRS occasion and D-Burst as follows.

(1) U-DRS occasion starts earlier than D-Burst

(2) U-DRS occasion starts later than D-Burst

(3) L-Cell and U-Cell align subframe index

Hereinafter, in each case, issues related to data rate matching when U-DRS transmission and D-Burst overlap with each other partially or fully in time, assuming L-Cell and U-Cell may not align subframe index, are described according to embodiments of the present invention.

(1) U-DRS occasion starts earlier than D-Burst

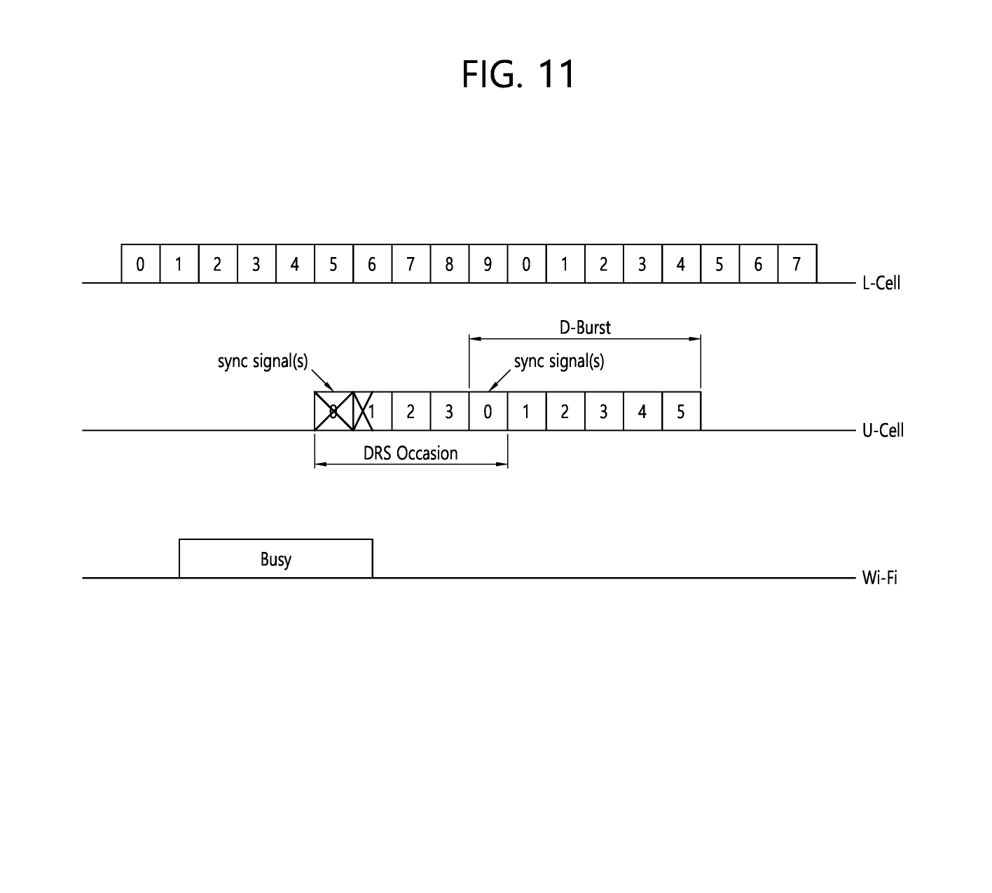

FIG. 11 shows an example of data rate matching for U-DRS according to an embodiment of the present invention. Referring to FIG. 11, U-DRS occasion starts earlier than D-Burst. If LBT is performed for U-DRS transmission and option (2-3) described above is used, partial U-DRS transmission may occur at subframe #1 of U-Cell and subframe #0 and #1 may not be transmitted, because the channel is busy until middle of subframe #1 of U-Cell.

Since reference signals transmitted in U-DRS may also have scrambling sequence associated with subframe index or mini-subframe index, subframe index for subframes in which U-DRS is transmitted may also be necessary. For example, if option (2-3) described above is used, subframe index #0 may be the first subframe of U-DRS occasion. However, in the embodiment of FIG. 11, since the first and second subframes may not be transmitted due to channel busy, the subframe index #2 may be the first subframe of U-DRS occasion. In this case, synchronization signals may not be transmitted. In other words, synchronization signals may be transmitted at the first subframe #0 or #5. Meanwhile, when D-Burst starts, subframe index needs to be changed. In this case, the fifth subframe (subframe #4 from U-DRS perspective, and subframe #0 from D-Burst perspective) may have collision from perspective of the subframe index. Thus, to avoid this collision, a UE may need to assume that subframe index used by D-Burst takes the higher priority than subframe index used by U-DRS. Thus, in this case, fifth subframe may assigned by subframe #0, and synchronization signals may be transmitted in that subframe if synchronization signals are transmitted in the first subframe of D-Burst.

In other words, before D-Burst, a UE may follow U-DRS configuration for RS transmission, and from starting of D-Burst, rate matching may follow D-Burst configuration. However, this may create some confusion issue for neighbor cell measurements. For example, if subframe index changes in the middle of U-DRS transmission, RS may not be easily decodable. In this case, a UE may not use those subframes with different subframe index. Or, RS may be scrambled independently from subframe or mini-subframe indices. In terms of transmission of RS, RS for U-DRS may be transmitted in U-DRS occasion duration regardless of whether the same RS is transmitted within D-Burst or not. For example, if CRS is transmitted during U-DRS occasion and CRS is not transmitted in D-Burst, during U-DRS occasion duration, a UE may assume that CRS will be transmitted. Thus, for data rate matching, a UE may assume data rate matching around CRS during U-DRS occasion.

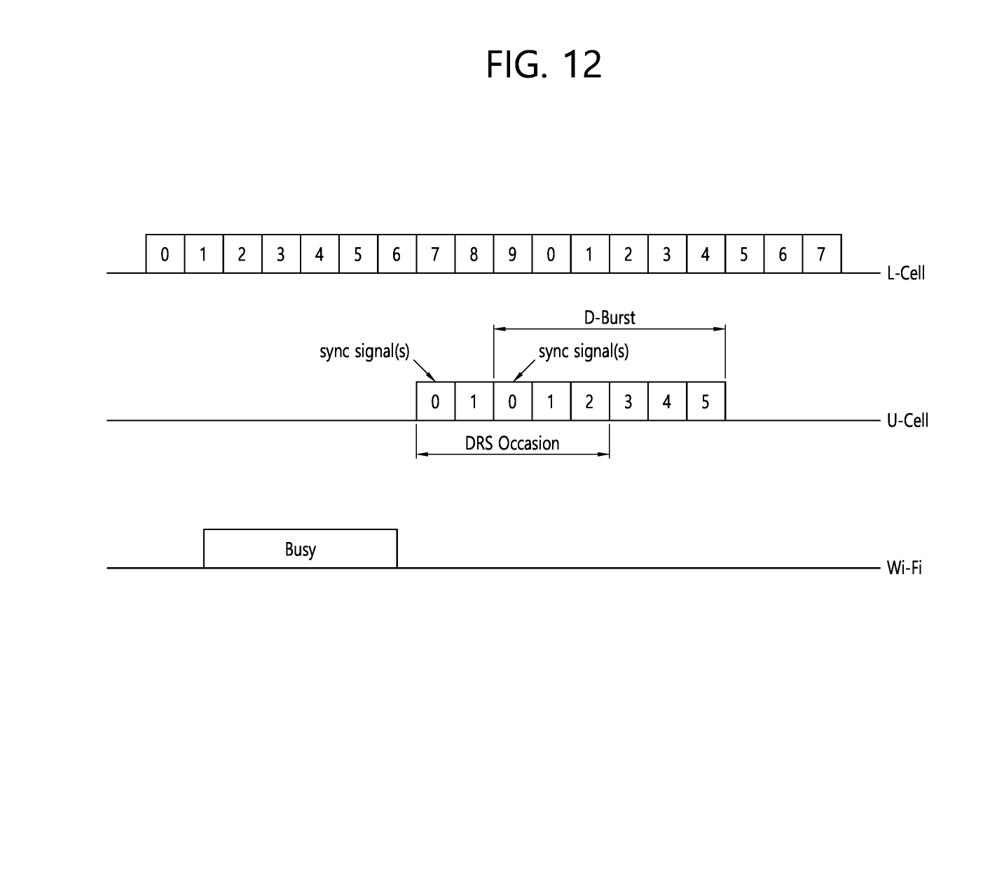

FIG. 12 shows another example of data rate matching for U-DRS according to an embodiment of the present invention. Referring to FIG. 12, U-DRS occasion starts earlier than D-Burst, and option (2-1) described above is used. That is, U-DRS transmission is shifted after the channel becomes idle. In this case, a UE needs to perform blind decoding at each subframe to determine which RS(s) are transmitted in that subframe. More specifically, if U-DRS transmission is shifted and starts in the middle of DRS occasion, unless a UE always detects the starting subframe of U-DRS transmission, the UE may not know how many subframes of DRS occasion has been transmitted before the starting of D-Burst.

For example, in the embodiment of FIG. 12, third subframe of U-DRS transmission collides with the first subframe of D-Burst. However, if the UE does not detect the starting subframe of U-DRS transmission, the UE does not know which subframe, and what RS(s) may be transmitted in subframe #0/#1/#2 of the D-Burst. If different combination of synchronization signals and RS may be possible in different subframes within U-DRS occasion, a UE may have to perform blind detection of multiple candidates unless it always detects the first transmission of U-DRS of the serving cell. If a UE has to detect the starting subframe of U-DRS transmission of the serving cell, it becomes challenging to perform measurement on neighbor cells and inter-frequency measurements following the current measurement gap configuration.

At least, a UE with possible D-Burst configuration may have to detect starting subframe of U-DRS transmission to avoid possible ambiguity in terms of data rate matching. In addition, a UE may also assume any RS/synchronization signals used for D-Burst are also transmitted, thus, assume rate matching around those as well.

Thus, if D-Burst starts with subframe #0 (or starting with a special subframe carrying special signals), option (2-3) may be more desirable than option (2-1).

(2) U-DRS occasion starts later than D-Burst

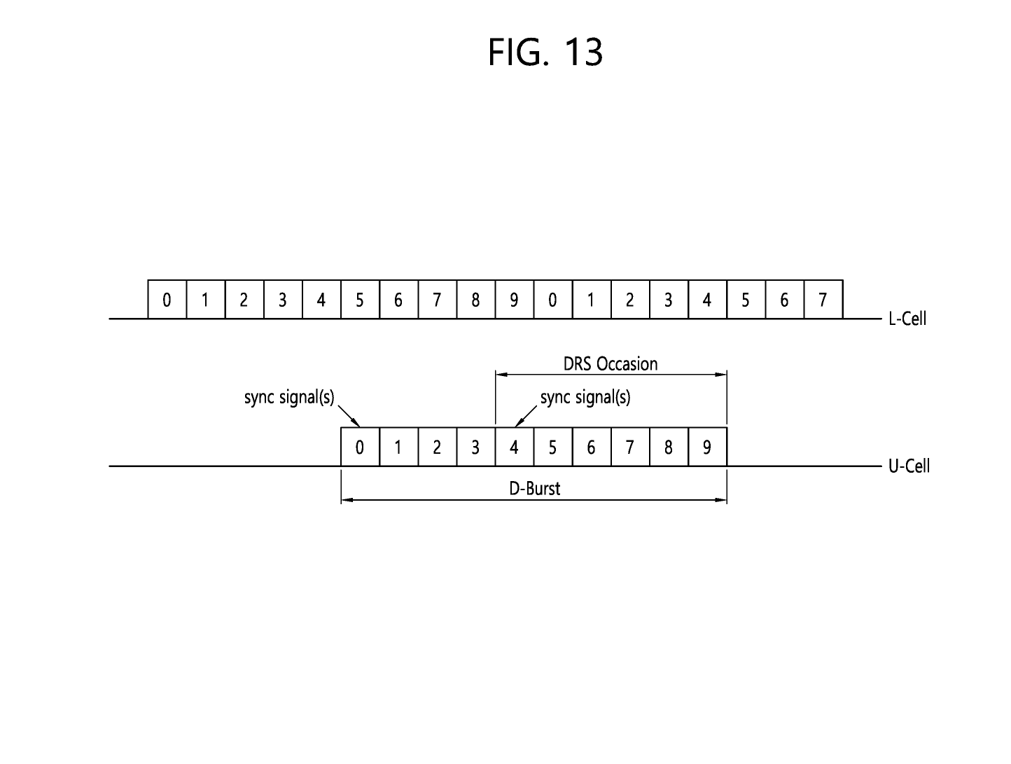

FIG. 13 shows another example of data rate matching for U-DRS according to an embodiment of the present invention. Referring to FIG. 13, U-DRS occasion starts later than D-Burst. In this case, similar to the first case described above, to be able to support floating subframe index by D-Burst, U-DRS may be transmitted/scrambled without association with subframe index or U-DRS occasion may have higher priority over D-Burst. The subframe index may re-starts when U-DRS occasion starts. When D-Burst starts, since no additional LBT is required for U-DRS transmission, a UE may safely assume that U-DRS from a serving cell may be transmitted as long as the entire duration can satisfy the regulatory requirements. U-DRS occasion may be stopped in the middle if the D-Burst duration cannot be extend. Even though this case is different from option (2-3), the same principle may be applied in which the network may not transmit U-DRS if U-DRS transmission more than minimum DRS occasion cannot be guaranteed. In this case, it may be also considered that the starting subframe of D-Burst is also transmitting synchronization/reference signals in the first subframe of U-DRS occasion such that a UE may perform measurement at least for the serving cell.

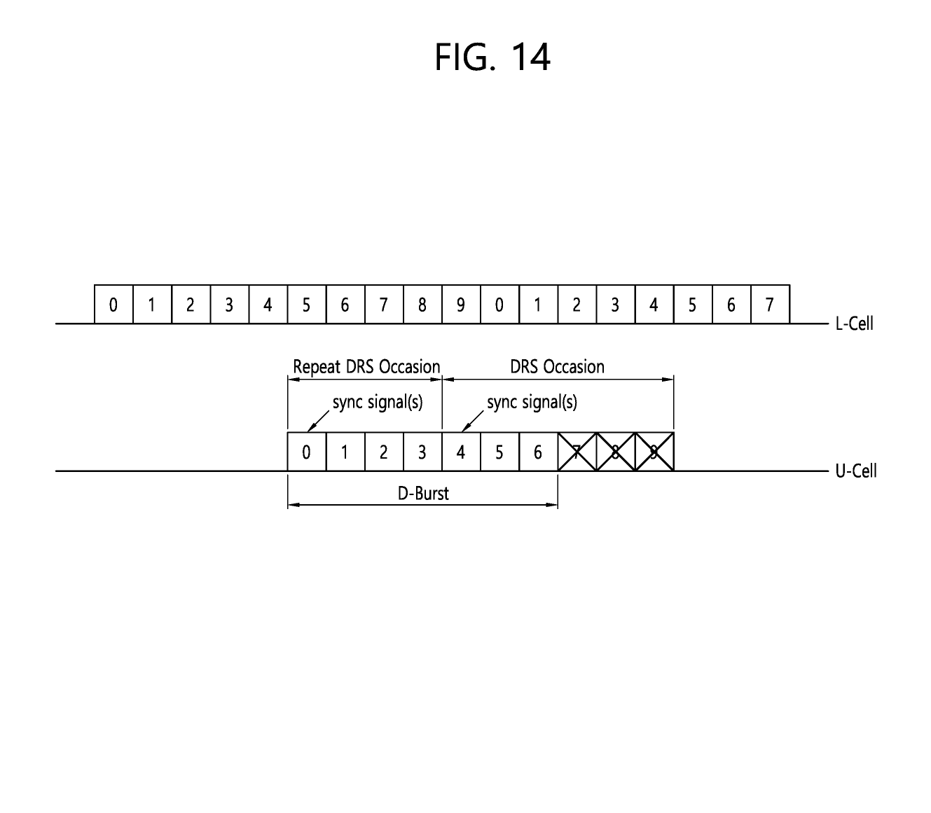

FIG. 14 shows another example of data rate matching for U-DRS according to an embodiment of the present invention. Referring to FIG. 14, U-DRS occasion starts later than D-Burst. The UE may know potential duration of D-Burst such that the UE knows whether U-DRS from the serving cell will be transmitted or not. In this case, DRS occasion (repetition) can occur in the beginning of U-Cell. In other words, if D-Burst starts less than m subframes before U-DRS transmission, the network may transmit U-DRS starting from the first subframe, and the actual U-DRS occasion may also start from the configured U-DRS occasion. In addition, a UE may also assume any RS/synchronization signals used for D-Burst are also transmitted, thus, assume rate matching around those as well.

(3) L-Cell and U-Cell align subframe index

As long as the first subframe of U-DRS occasion and D-Burst uses the same RS/synchronization signal transmission, this case may not cause any issue for perspective of rate matching. In case different configurations are used, a UE may assume all RS/synchronization signals are transmitted for either D-Burst or U-DRS occasion. Thus, all RS/synchronization signal will be rate matched used both for U-DRS and D-Burst.

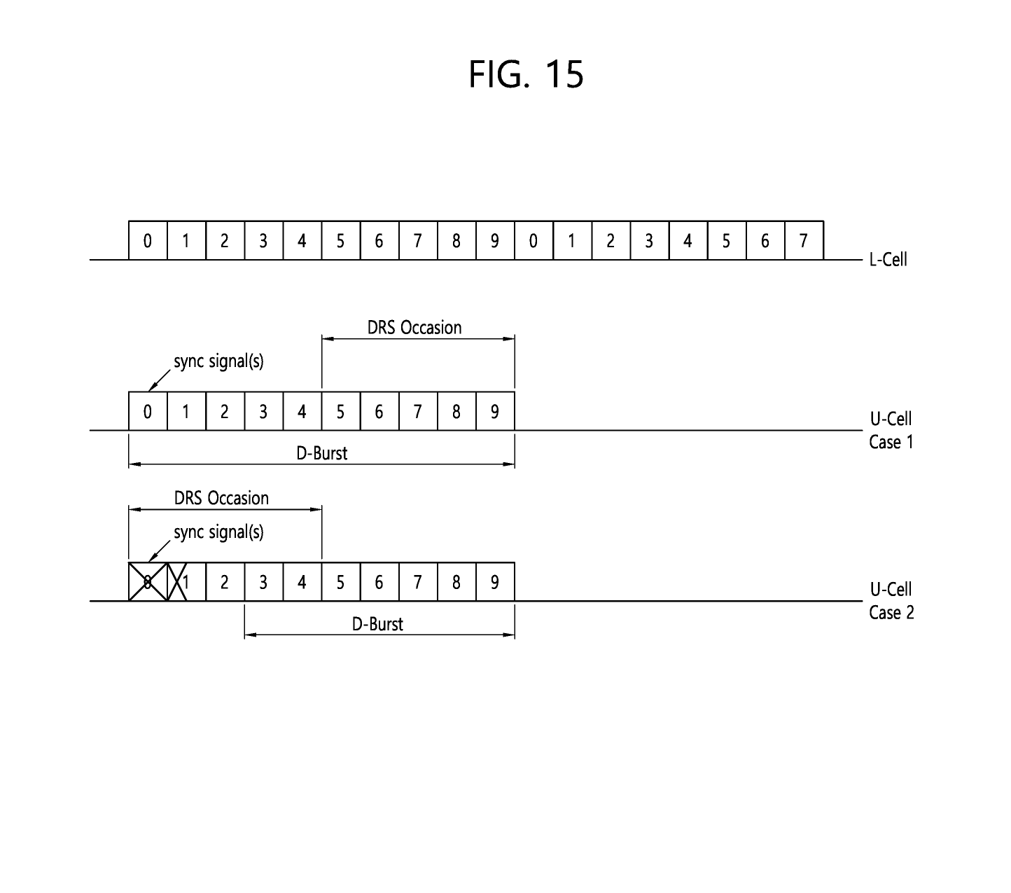

FIG. 15 shows another example of data rate matching for U-DRS according to an embodiment of the present invention. Referring to FIG. 15, L-Cell and U-Cell align subframe index and option (2-3) is used. A UE may assume that RS/synchronization signals follow subframe index. For example, if U-DRS occasion starts later than D-Burst, synchronization signals may be transmitted either in subframe #0 or #5. If U-DRS occasion starts earlier than D-Burst, synchronization signals may be transmitted either in subframe #5. Further, additional U-DRS may be transmitted if RS/synchronization signals configuration is different between U-DRS and D-Burst. For example, U-DRS may be transmitted at subframe #5.

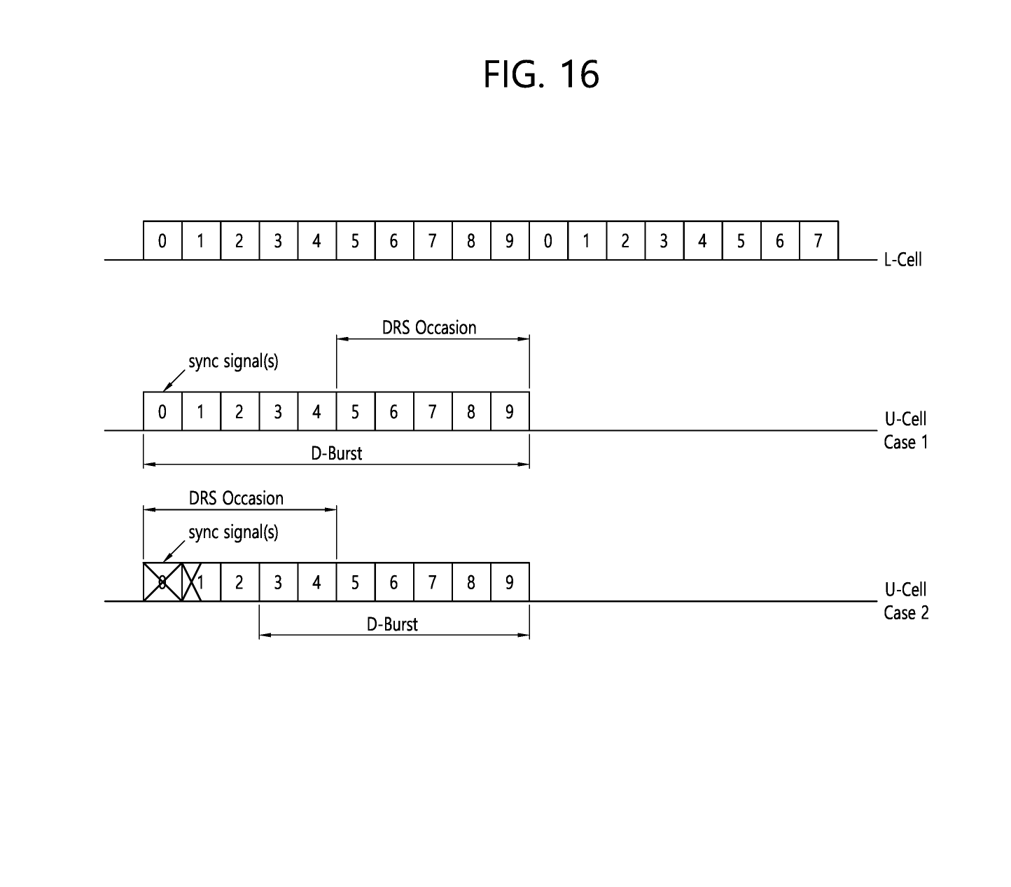

FIG. 16 shows another example of data rate matching for U-DRS according to an embodiment of the present invention. Referring to FIG. 16, L-Cell and U-Cell align subframe index and option (2-1) is used. In this case, additional synchronization signals may be also transmitted in the first subframe of U-DRS (i.e. subframe #2). In this case, a UE always has to blindly detect the first subframe of U-DRS. In case a UE cannot perform blind detection to discover the starting subframe of U-DRS transmission, a UE may not assume U-DRS transmission for rate matching. This can be achieved either by the network not to schedule U-DRS and D-Burst at the same time, or via puncturing on RS REs used for U-DRS if both collide in the same subframe.

In general, at least one of the following approaches may be considered.

(1) Similar to current system, a UE may assume that synchronization signal (e.g. SSS) will be transmitted in either subframe #0 or #5, if the network transmits any signals (either D-Burst or U-DRS, etc.). In this case, in other subframes, a UE may assume that synchronization signals are not transmitted.

(2) Regardless of U-DRS transmission, the first subframe of D-Burst may transmit synchronization signals. When U-DRS and D-Burst overlaps with each other, both signals/RS from U-DRS and D-Burst may be assumed as present for data rate matching purpose. In case a UE does not know location of U-DRS transmission, for the data rate matching, U-DRS may not be transmitted.

(3) Synchronization signals may be transmitted only in U-DRS, so synchronization signals may not be transmitted in D-Burst unless D-Burst overlaps with U-DRS.

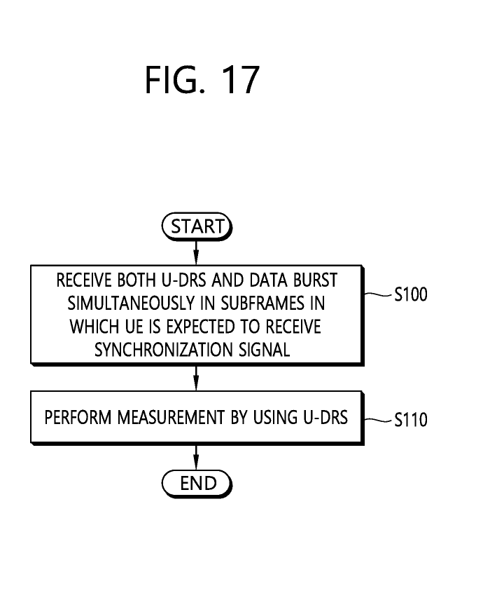

FIG. 17 shows a method for performing measurement according to an embodiment of the present invention.

In step S100, the UE receives both U-DRS and data burst simultaneously in subframes in which the UE is expected to receive a synchronization signal in an unlicensed carrier. The subframes in which the UE is expected to receive the synchronization signal may be subframes having an index of 0 and 5. A subframe index of the unlicensed carrier and a subframe index of a licensed carrier may align with each other. The U-DRS may be received in a DRS occasion. The DRS occasion may start earlier than the beginning of reception of the data burst, or later than the beginning of reception of the data burst. The UE may further perform LBT at the beginning of the DRS occasion. Both the U-DRS and data burst may not be received simultaneously in subframes having an index other than 0 and 5 in the unlicensed carrier. The U-DRS may consists of at least one of PSS, PSS, CRS or CSI-RS.

In step S110, the UE performing measurement by using the U-DRS.

Meanwhile, in case short TTI is introduced, the rate matching may be different. In short TTI which does not have any DRS (which is transmitted in legacy subframe as TTI), RS may be used for data transmission for short TTI, e.g. with 2 OFDM symbol length which maps to 01-DM symbol #2/#3 in the second slot, if CSI-RS is not configured to be transmitted in that duration and/or zero-power (ZP)-CSI-RS configuration is not configured in that duration. In other words, a common signaling to indicate which RS may be present in a legacy subframe may be used for data transmission in short TTI. Or, a UE may make safe assumption regarding RS/signal transmission under legacy TTI.

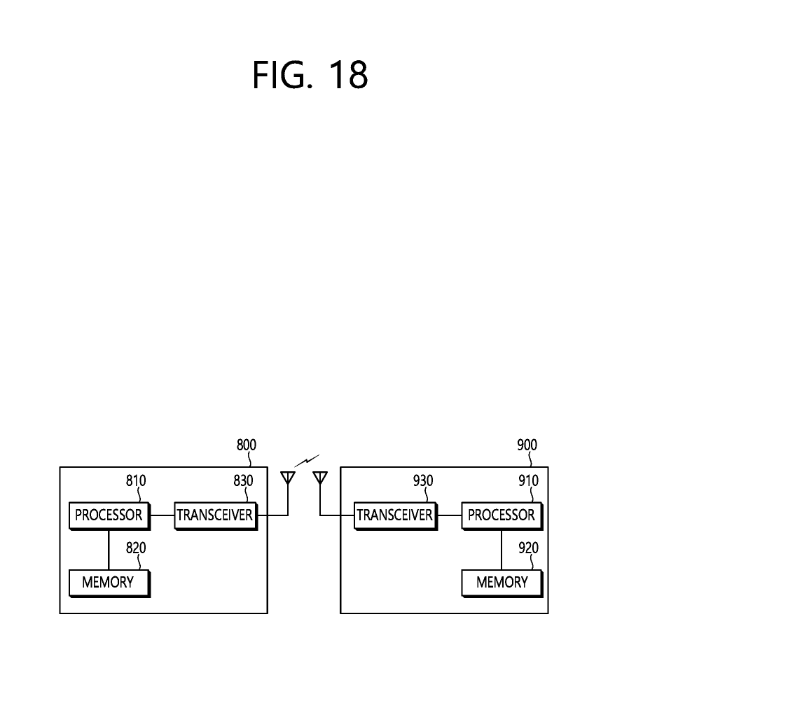

FIG. 18 shows a wireless communication system to implement an embodiment of the present invention.

A network 800 may include a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 may include a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for performing, by a user equipment (UE), measurement in a wireless communication system, the method comprising:
receiving both an unlicensed discovery reference signal (U-DRS) and data burst simultaneously in subframes in which the UE is expected to receive a synchronization signal in an unlicensed carrier; and
performing measurement by using the U-DRS.

2. The method of claim 1, wherein the subframes in which the UE is expected to receive the synchronization signal are subframes having an index of 0 and 5.

3. The method of claim 1, wherein a subframe index of the unlicensed carrier and a subframe index of a licensed carrier align with each other.

4. The method of claim 1, wherein the U-DRS is received in a DRS occasion.

5. The method of claim 4, wherein the DRS occasion starts earlier than the beginning of reception of the data burst.

6. The method of claim 4, wherein the DRS occasion starts later than the beginning of reception of the data burst.

7. The method of claim 4, further comprising performing listen-before-talk (LBT) at the beginning of the DRS occasion.

8. The method of claim 1, wherein both the U-DRS and data burst are not received simultaneously in subframes having an index other than 0 and 5 in the unlicensed carrier.

9. The method of claim 1, wherein the U-DRS consists of at least one of a primary synchronization signal (PSS), a secondary synchronization signal (SSS), a cell-specific reference signal (CRS) or a channel state information reference signal (CSI-RS).

10. A user equipment (UE) in a wireless communication system, the UE comprising:
a memory;
a transceiver; and
a processor coupled to the memory and the transceiver,
wherein the processor is configured to:
control the transceiver to receive both an unlicensed discovery reference signal (U-DRS) and data burst simultaneously in subframes in which the UE is expected to receive a synchronization signal in an unlicensed carrier; and
perform measurement by using the U-DRS.

11. The UE of claim 10, wherein the subframes in which the UE is expected to receive the synchronization signal are subframes having an index of 0 and 5.

12. The UE of claim 10, wherein a subframe index of the unlicensed carrier and a subframe index of a licensed carrier align with each other.

13. The UE of claim 10, wherein the U-DRS is received in a DRS occasion.

14. The UE of claim 13, wherein the DRS occasion starts earlier than the beginning of reception of the data burst.

15. The UE of claim 13, wherein the DRS occasion starts later than the beginning of reception of the data burst.
